(19) United States
(12) Patent Application Publication
(10) Pub. No.: US 2008/0111360 A1
(43) Pub. Date: May 15, 2008

(54) KNEE AIRBAG MODULE FOR VEHICLE

(75) Inventor: Hun Hee JEONG, Kyungki-do (KR)

Correspondence Address: GREENBLUM & BERNSTEIN, P.L.C., 1950 ROLAND CLARKE PLACE, RESTON, VA, 20191, US

(73) Assignee: HYUNDAI MOBIS CO. LTD., Kyunggi-do (KR)

(21) Appl. No.: 11/561,587

(22) Filed: Nov. 20, 2006

(30) Foreign Application Priority Data
Nov. 14, 2006 (KR) 10-2006-0112240

(51) Int. Cl. B60R 21/16

(52) U.S. Cl. 280/743.1

(57) ABSTRACT

In accordance with a knee airbag module for a vehicle according to the present invention, an airbag cushion is folded in half in the front and rear directions, folded in the left and right directions, and is then contained. Thus, when the airbag cushion is supplied with a high pressure gas, it is expanded and unfolded in the left and right directions and is then expanded and unfolded in the front and rear directions. Therefore, the airbag cushion is not unfolded between the knees of a passenger, but is unfolded at the front of the knees of the passenger. Accordingly, the unfolding performance and stability can be improved.

### BACKGROUND OF THE INVENTION

This application claims the benefit of Korean Patent Application No. 10-2006-0112240 filed on Nov. 14, 2006, which is hereby incorporated by reference for all purposes as if fully set forth herein.

1. Field of the Invention

The present invention relates, in general, to an airbag module for a vehicle. More particularly, the present invention relates to a knee airbag module for a vehicle, in which an airbag cushion is folded in half in the front and rear directions, folded in the left and right directions, and is then contained, so that it can be unfolded more smoothly in the left and right direction at the time of an initial unfolding of the airbag cushion, thus improving the unfolding performance and stability.

2. Background of the Related Art

In general, an airbag system includes a driver airbag installed to protect a driver, a passenger airbag installed to protect a passenger in the front seat, side airbags configured to expand from the doors in order to protect the sides of a driver, passengers, etc., a knee airbag installed to protect the knees of a driver or passengers.

FIG. 1 is a lateral view showing a conventional knee airbag module for a vehicle.

The conventional knee airbag is mounted at the bottom of a dash panel 4 having a steering wheel 2 installed therein, as illustrated in FIG. 1. The knee airbag includes an airbag cushion 6 contained within the dash panel 4 with it being folded and unfolded toward the knee of a passenger when a vehicle hits something, and an inflator 8 configured to supply a high pressure gas to the airbag cushion 6.

The airbag cushion 6 has one side opened to which the high pressure gas is supplied from the inflator 8.

In the conventional knee airbag constructed above, if a sensor senses impact when a vehicle hits something, the inflator 8 is actuated to supply the high pressure gas to the airbag cushion 6.

The airbag cushion 6 is expanded to a specific volume by means of the high pressure gas and is then unfolded toward the knee of a passenger. Accordingly, the knee of the passenger can be prevented from being injured due to the hit on the dash panel 4 at the front.

In the conventional knee airbag, however, when the airbag cushion 6 is unfolded, it is unfolded between both knees of a passenger. Accordingly, the performance of the airbag is low.

Furthermore, an addition tether, etc. is added in order to prevent the problem. In this case, however, problems arise because the cost increases, a folding work is lowered, and so on.

### SUMMARY OF THE INVENTION

Accordingly, the present invention has been made in view of the above problems occurring in the prior art, and it is an object of the present invention to provide a knee airbag module for a vehicle, in which an airbag cushion can be smoothly unfolded toward the front of the knees of a passenger.

To achieve the above object, the knee airbag module for a vehicle according to the present invention includes an airbag cushion contained in a vehicle body and unfolded toward knees of a passenger when the vehicle collides against something, and an inflator configured to supply the airbag cushion with a high pressure gas. The airbag cushion is folded in front and rear directions so that a front-end part directed toward the passenger is directed toward a rear-end part coupled to the inflator, and is then folded and contained so that it narrows widths of left and right directions.

The airbag cushion is folded in half when being folded in the front and rear directions.

The airbag cushion includes left and right sides, which are respectively folded toward the center in an accordion manner so that the airbag cushion narrows the widths of the left and right directions.

The left and right sides of the airbag cushion are folded in the accordion manner and are then folded in a roll manner in the front and rear directions.

The airbag cushion is made by sewing at least one leaf of fabric.

### BRIEF DESCRIPTION OF THE DRAWINGS

Further objects and advantages of the invention can be more fully understood from the following detailed description taken in conjunction with the accompanying drawings in which:

FIG. 1 is a lateral view showing a conventional knee airbag module for a vehicle;

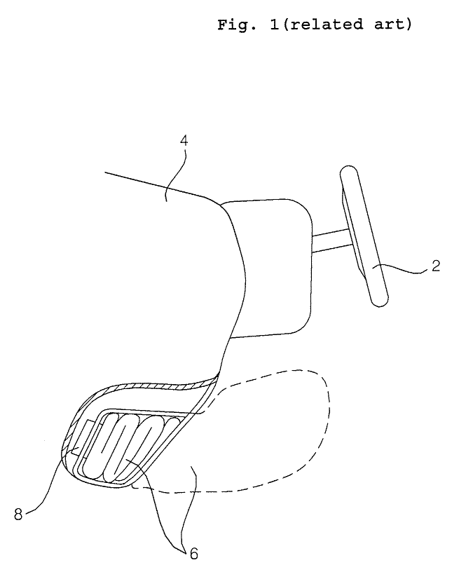

FIGS. 2(a) to 2(d) are schematic views illustrating the folding sequence of an airbag cushion according to an embodiment of the present invention; and

FIG. 3 is a lateral view of the airbag cushion, which is viewed in a direction A of FIG. 2(c).

### DETAILED DESCRIPTION OF THE PREFERRED EMBODIMENT

The present invention will now be described in detail in connection with a specific embodiment with reference to the accompanying drawings.

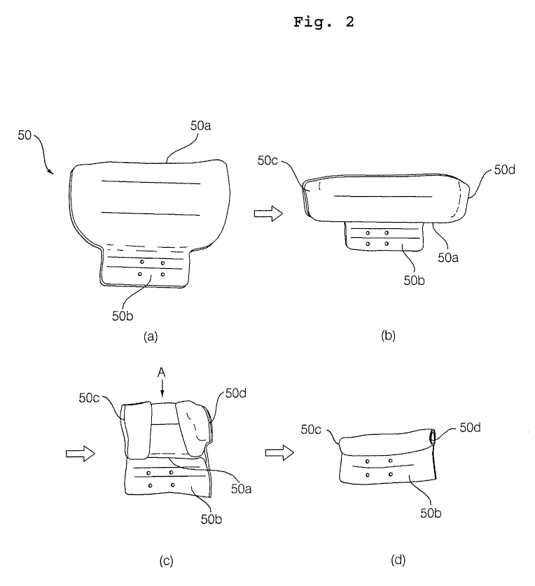

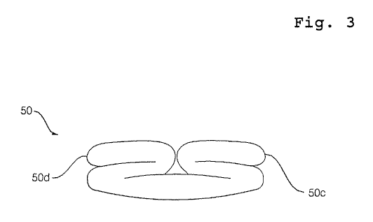

FIGS. 2(a) to 2(d) are schematic views illustrating the folding sequence of an airbag cushion according to an embodiment of the present invention. FIG. 3 is a lateral view of the airbag cushion, which is viewed in a direction A of FIG. 2(c).

The knee airbag module for a vehicle according to an embodiment of the present invention includes an airbag housing (not shown), mounted at the bottom of a dash board (not shown) of the vehicle body, an airbag cushion 50 contained within the airbag housing (not shown) with it being folded, and an inflator (not shown) for supplying the airbag cushion 50 with a high pressure gas.

The airbag cushion 50 is made of at least one sheet of fabric sewed.

The airbag cushion 50 has one side, forming a filling room. The filling room is filled with the high pressure gas and is unfolded so that the airbag cushion 50 is unfolded toward a passenger when an impact accident occurs. The airbag cushion 50 has the other side fixed to the airbag housing (not shown) and the inflator (not shown) and opened so that the high pressure gas is supplied from the inflator (not shown).

The airbag cushion 50 is first folded so that a front-end part 50a toward a passenger is directed toward a rear-end part 50b coupled to the inflator, as illustrated in FIG. 2(b).

In other words, the filling room of the airbag cushion 50 is folded in half in the front and rear directions.

As illustrated in FIG. 2(c), left and right sides 50c and 50d of the airbag cushion 50 are folded toward the center in an accordion manner so that it narrows the width of the left and right directions.

That is, the left and right sides 50c and 50d of the airbag cushion 50 are folded like wrinkles of the accordion.

If the left and right sides 50c and 50d of the airbag cushion 50 are folded in the accordion manner, the airbag cushion 50 is rolled and folded in the front and rear directions, as illustrated in FIG. 2(d).

An unfolding operation of the knee airbag cushion constructed above according to an embodiment of the present invention will be described below.

If an impact is sensed when an impact accident of a vehicle occurs, the inflator (not shown) is actuated to supply the airbag cushion 50 with the high pressure gas.

At this time, since the airbag cushion 50 is folded in half in the front and rear directions, the gas supplied to the airbag cushion 50 does not proceed to the front, but is dispersed at the center in the left and right directions.

Therefore, the airbag cushion 50 is expanded and unfolded in the left and right directions at the time of initial unfolding.

Furthermore, the airbag cushion 50 is folded in the accordion manner in the left and right directions and is then folded in the rolling manner in the front and rear directions. Thus, the portion folded in the accordion manner is expanded and unfolded in the left and right directions and the portion folded in the rolling manner is then expanded and unfolded in the front and rear directions, with respect to the center, by means of the gas, which is continuously supplied.

Accordingly, the airbag cushion 50 can be smoothly expanded and unfolded in the left and right directions at the time of initial unfolding. Thus, the airbag cushion 50 is not unfolded between the knees of a passenger, but is unfolded at the front of the knees of the passenger, thus protecting the knees.

As described above, in accordance with the knee airbag module for a vehicle according to the present invention, the airbag cushion is folded in half in the front and rear directions, folded in the left and right directions, and is then contained. Thus, when the airbag cushion is supplied with a high pressure gas, it is expanded and unfolded in the left and right directions and is then expanded and unfolded in the front and rear directions. Consequently, the airbag cushion is not unfolded between the knees of a passenger, but is unfolded at the front of the knees of the passenger. Accordingly, there is an advantage in that the unfolding performance and stability can be improved.

While the present invention has been described with reference to the specific embodiment, it is not to be restricted by the embodiments but only by the appended claims. It is to be appreciated that those skilled in the art can change or modify the embodiments without departing from the scope and spirit of the present invention.

What is claimed is:

1. A knee airbag module for a vehicle, comprising:
an airbag cushion contained in a vehicle body and unfolded toward knees of a passenger when the vehicle collides against something; and
an inflator configured to supply the airbag cushion with a high pressure gas,
wherein the airbag cushion is folded in front and rear directions so that a front-end part directed toward the passenger is directed toward a rear-end part coupled to the inflator, and is then folded and contained so that it narrows widths of left and right directions.

2. The knee airbag module of claim 1, wherein the airbag cushion includes left and right sides, which are respectively folded toward the center in an accordion manner so that the airbag cushion narrows the widths of the left and right directions.

3. The knee airbag module of claim 2, wherein the left and right sides of the airbag cushion are folded in the accordion manner and are then folded in a roll manner in the front and rear directions.

4. The knee airbag module of claim 1, wherein the airbag cushion is folded in half when being folded in the front and rear directions.

5. The knee airbag module of claim 4, wherein the airbag cushion includes left and right sides, which are respectively folded toward the center in an accordion manner so that the airbag cushion narrows the widths of the left and right directions.

6. The knee airbag module of claim 5, wherein the left and right sides of the airbag cushion are folded in the accordion manner and are then folded in a roll manner in the front and rear directions.

7. The knee airbag module of claim 1, wherein the airbag cushion is made by sewing at least one leaf of fabric.

8. A method of providing an airbag for protecting knees of an occupant of a vehicle, comprising:
providing an airbag cushion to be contained in a vehicle body such that the airbag cushion is configured to unfold towards the knees of the occupant when the airbag is actuated;
folding a front end of the airbag cushion towards a rear end of the air bag cushion such that the front end of the airbag cushion, which is configured to face an occupant when actuated, is directed towards the rear end which is coupled to the inflator;
folding the air bag cushion so that the airbag cushion becomes narrower in a width direction of the airbag cushion; and
providing an inflator configured to supply the airbag cushion with a high pressure gas.

9. The method according to claim 8, further comprising folding oppositely facing sides of the airbag cushion toward a center of the airbag cushion, in an accordion fashion, such that the width of the airbag cushion is narrowed.

10. The method according to claim 9, further comprising rolling the airbag in a forward to rearward direction.

11. The method according to claim 8, further comprising folding the airbag cushion such that the airbag cushion is folded in half when folding the front end of the airbag cushion towards the rear end of the air bag cushion.

12. The method according to claim 8, further comprising providing the airbag cushion by folding at least one leaf of fabric.
